(19) United States
(12) Patent Application Publication
(10) Pub. No.: US 2025/0260701 A1
(43) Pub. Date: Aug. 14, 2025

(54) NEURAL NETWORK INTRUSION DETECTION SYSTEM IN EDGE SYSTEM

(71) Applicant: Dell Products L.P., Round Rock, TX (US)

(72) Inventors: Parminder Singh Sethi, Ludhiana (IN); Srinath Kappgal, Cork (IE); Praveen Kumar, Noida (IN)

(21) Appl. No.: 18/436,232

(22) Filed: Feb. 8, 2024

(51) Int. Cl. H04L 9/40; H04L 41/16

(52) U.S. Cl. CPC H04L 63/1425; H04L 41/16

(57) ABSTRACT

A neural network intrusion detection system (NNIDS) monitors network traffic between a plurality of devices in a system to obtain raw traffic data, processes the raw traffic data to obtain processed traffic data, applies an intrusion detection model to the processed traffic data, makes a determination, based on the applying, that an anomaly is detected in the processed traffic data, and based on the determination, implements a data privacy protection policy to remediate the anomaly.

### BACKGROUND

In a computing environment, the training of models to identify and predict security breaches can be very effective in preventing an attack. In such computing environment, the security breaches may be known or unknown attacks. It may be beneficial to analyze the network traffic to determine whether a given anomaly may result in a security breach (known or unknown) and remediate accordingly.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1A shows a diagram of a system including a neural network intrusion detection system (NNIDS) in accordance with one or more embodiments of the invention.

FIG. 1B shows a diagram of an NNIDS in accordance with one or more embodiments of the invention.

FIG. 2A shows a flowchart of a method for generating an intrusion detection model in accordance with one or more embodiments of the invention.

FIG. 2B shows a flowchart of a method for detecting an attack in accordance with one or more embodiments of the invention.

FIG. 3 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regards to any other figure. For brevity, descriptions of these components will not be repeated with regards to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this application, elements of the figures may be labeled as A to N. As used herein, the aforementioned labeling means that the element may include any number of items and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

In general, embodiments of the invention relate to system and methods for using a neural network intrusion detection system (NNIDS) in order to detect and protect against system attacks. Embodiments disclosed herein utilize machine learning algorithms and real-time monitoring of traffic in a system in order to predict against and prevent new attacks against the system. The NNIDS may integrate into existing cybersecurity infrastructures, such as, Dell APEX™. Using the NNIDS, the system may identify any anomalies in the network traffic of the system. Based on detected anomalies, the system continues to improve the intrusion detection model over time making use of neural networks. One or more embodiments of the invention improves upon the previous method of protecting against cyber-attacks. Current intrusion detection software struggles with identifying attack patterns that are previously unknown to the system, allowing threats to surpass the security system in place. With the NNIDS, advanced neural network machine learning algorithms are used to identify any traffic in the system that may pose a threat, while subsequently implementing data privacy measures to protect the system.

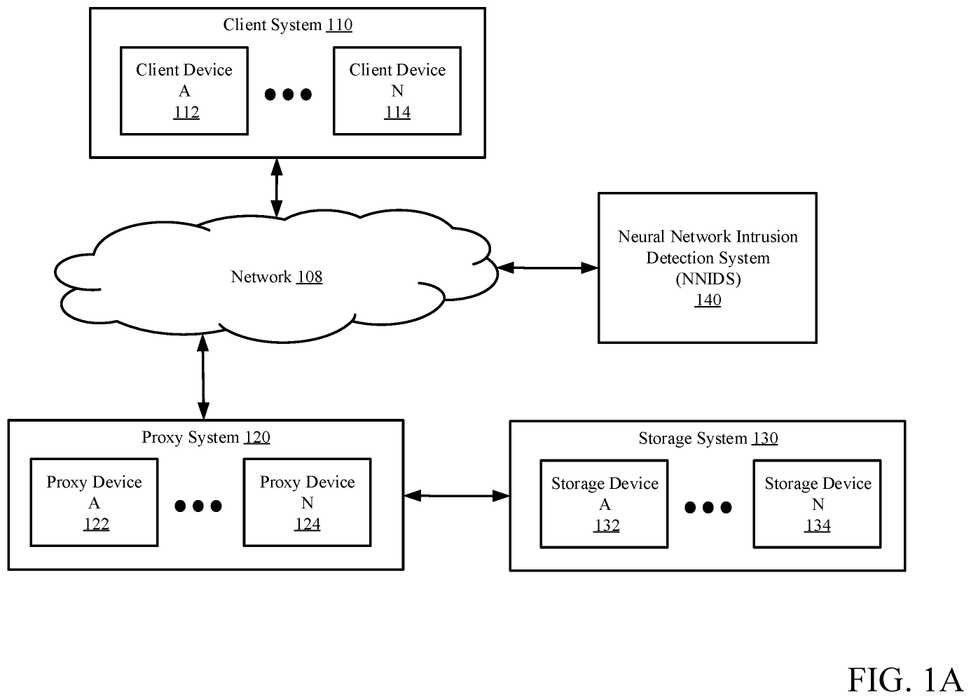

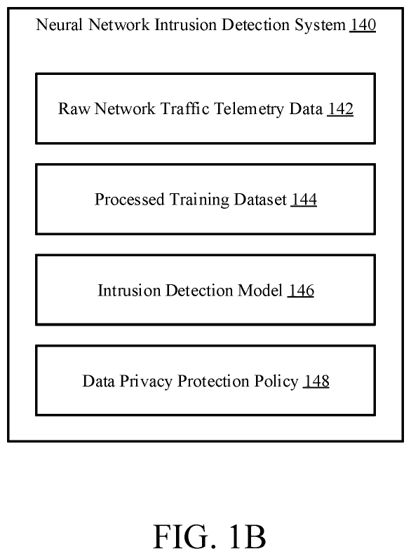

FIG. 1A shows a diagram of a system in accordance with one or more embodiments of the invention. The system may include a network (108), a client system (110), a proxy system (120), a storage system (130), and a neural network intrusion detection system (NNIDS) (140). The system may include additional, fewer, and/or other components without departing from the invention. Each of the components in the system may be operatively connected via any combination of wireless and/or wired networks, e.g., the network (108).

In one or more embodiments, the network (108) is the network that performs the functionality of allowing communication between components of the system described throughout this application. A network (e.g., network (108)) may refer to an entire network or any portion thereof (e.g., a logical portion of the devices within a topology of devices). A network may include a data center network, wide area network, local area network, wireless network, cellular phone network, and/or any other suitable network that facilitates the exchange of information from one part of the network to another. A network may be located at a single physical location or be distributed at any number of physical sites. In one or more embodiments, a network may be coupled with or overlap, at least in part, with the Internet.

In one or more embodiments, although shown separately in FIG. 1A, the network (108) may include any number of devices within any components (e.g., 110, 120, 130, 140) of the system, as well as devices external to or between such components of the system. In one or more embodiments, at least a portion of such devices are network devices (not shown). In one or more embodiments, a network device is a device that includes and/or is operatively connected to persistent storage (not shown), memory (e.g., random access memory (RAM)) (not shown), one or more processor(s) (e.g., integrated circuits) (not shown), and at least two physical network interfaces which may provide connections (i.e., links) to other devices (e.g., computing devices, other network devices, etc.). In one or more embodiments, a network device also includes any number of additional components (not shown) such as, for example, network chips, field programmable gate arrays (FPGAs), application specific integrated circuits (ASICs), indicator lights (not shown), fans (not shown), etc. A network device may include any other components without departing from the invention. Examples of a network device include, but are not limited to, a network switch, router, multilayer switch, fiber channel device, an InfiniBand® device, etc. A network device is not limited to the aforementioned specific examples.

The network (108) may include any number of devices within any components of the system, as well as devices external to or between such components of the system. The network (108) provides the operative connectivity between the client system (110), the proxy system (120), the storage system (130) and the NNIDS (140). Each of the aforementioned system components connected by the network (108) will be described in detail below.

In one or more embodiments, the client system (110) may include a plurality of client devices (112, 114) without departing from the scope of the invention. Client devices may include personal computers, such as desktops, laptops, tablets, or smartphones that are connected to the network (108). Personal data such as personal identification, medical records, financial documents, or a plurality of other documents that require cybersecurity and data privacy measures may be stored on these client devices (112, 114).

In one or more embodiments of the invention, each client device (112, 114) is implemented as a computing device. A computing device may be, for example, a mobile phone, tablet computer, laptop computer, desktop computer, server, distributed computing system, or cloud resource. The computing device may include one or more processors, memory (e.g., random access memory), and persistent storage (e.g., disk drives, solid state drives, etc.). The computing device may include instructions stored on the persistent storage, that when executed by the processor(s) of the computing device it causes the computing device to perform the functionality of a client device (112, 114) as described throughout this application.

In one or more embodiments of the invention, each client device (112, 114) is implemented as a logical device. The logical device may utilize the computing resources of any number of computing devices and thereby provide the functionality of a client device (112, 114) as described throughout this application.

In one or more embodiments, the proxy system (120) may include a plurality of proxy devices (122, 124) without departing from the scope of the invention. In one or more embodiments of the invention, each proxy device includes functionality for providing services to users of the client devices (112, 114). The services may include instances of applications such as email databases, backup servers, and/or other applications without departing from the invention. Any data generated by the applications executing in the proxy system (120) may be stored in the storage system (130). Further, the proxy system (120) may include security services such as, for example, providing monitored network traffic to the NNIDS (140) for use in anomaly detection.

In one or more embodiments, the proxy devices (122, 124) may be implemented using hardware, software, or any combination thereof and include functionality to process data. In one embodiment, the proxy devices (122, 124) may be implemented using a physical or logical computing device. The computing device may be, for example, a mobile phone, tablet computer, laptop computer, desktop computer, server, or cloud resource. The computing device may include one or more processors, memory (e.g., random access memory), and persistent storage (e.g., disk drives, solid state drives, etc.). The proxy system (120) may function as a go-between between the storage system (130) and the network (108).

In one or more embodiments, the storage system (130) may include a plurality of storage devices (132, 134) without departing from the scope of the invention. The storage system may include the functionality to, but is not limited to, provide storage services to the proxy system (120) and client system (110). The storage services may include the functionality to provide and/or obtain other services without departing from the invention. The storage system (130) may include any number of storage devices (132, 134) without departing from the invention.

In one or more embodiments of the invention, the storage system (130) is implemented as a computing device. A computing device may be, for example, a mobile phone, tablet computer, laptop computer, desktop computer, server, distributed computing system, or cloud resource. The computing device may include one or more processors, memory (e.g., random access memory), and persistent storage (e.g., disk drives, solid state drives, etc.). The computing device may include instructions stored on the persistent storage, that when executed by the processor(s) of the computing device it causes the computing device to perform the functionality of a storage system (130) as described throughout this application.

In one or more embodiments of the invention, the storage system (130) is implemented as a logical device. The logical device may utilize the computing resources of any number of computing devices and thereby provide the functionality of the storage system (106) as described throughout this application.

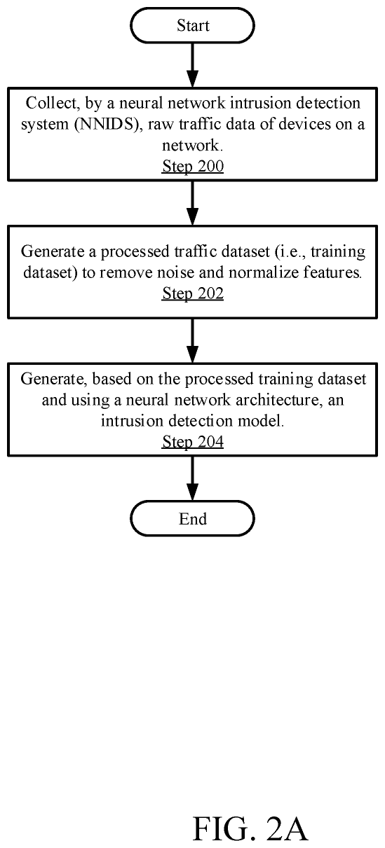

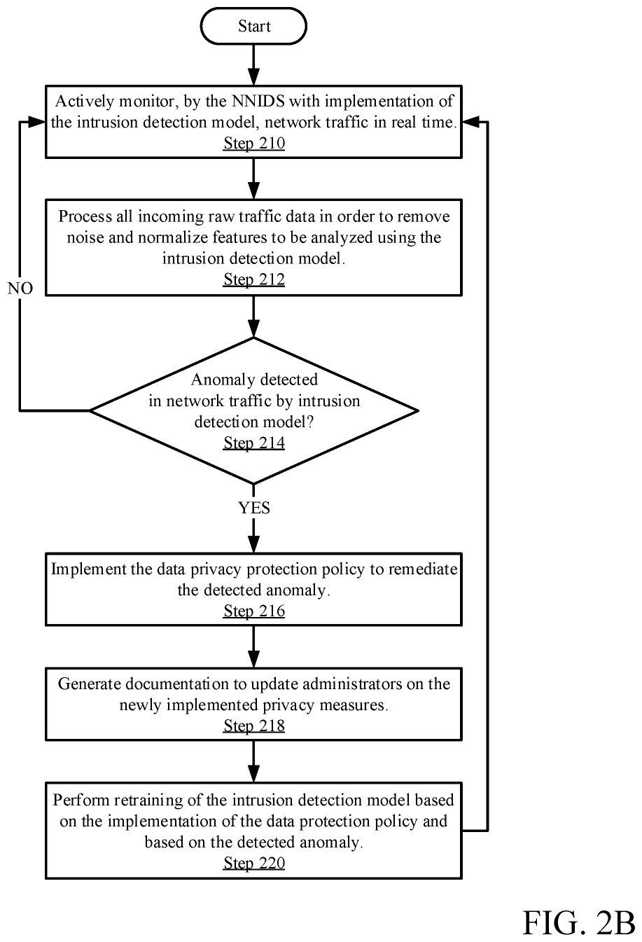

In one or more embodiments, the NNIDS (140) refers to the neural network intrusion detection system. This system includes functionality to implement real-time anomaly detection algorithms with the use of advances neural network architecture. Additional details on the NNIDS (140) may be found, for example, in FIG. 1B. The goal of the NNIDS is to identify and neutralize attacks on the overall system described above. Additional details for the functionality of the NNIDS may be found, for example, in FIGS. 2A-2B.

In one or more embodiments of the invention, the NNIDS (140) is implemented as a computing device. A computing device may be, for example, a mobile phone, tablet computer, laptop computer, desktop computer, server, distributed computing system, or cloud resource. The computing device may include one or more processors, memory (e.g., random access memory), and persistent storage (e.g., disk drives, solid state drives, etc.). The computing device may include instructions stored on the persistent storage, that when executed by the processor(s) of the computing device it causes the computing device to perform the functionality of the NNIDS (140) as described throughout this application.

In one or more embodiments of the invention, the NNIDS (140) is implemented as a logical device. The logical device may utilize the computing resources of any number of computing devices and thereby provide the functionality of the NNIDS (140) as described throughout this application.

Turning now to FIG. 1B, FIG. 1B shows a diagram of an NNIDS in accordance with one or more embodiments of the invention. The NNIDS (140) of FIG. 1B may be an embodiment of an NNIDS (140, FIG. 1A) discussed above. The NNIDS may include information such as raw network telemetry data (142), a processed training dataset (144), an intrusion detection model (146), and a data privacy protection policy (148). The NNIDS (140) may include additional, fewer, and/or different components without departing from the invention. Each of the aforementioned components of the NNIDS (140) is discussed below.

In one or more embodiments, the raw network traffic telemetry data (142) may include information about the operation (e.g., workload, available resources, etc.) of devices on the network (108) during a period of time. This data may include information on any requests (or other information such as data packets) occurring on the system that the NNIDS (140) is monitoring in real time, with information such as their size, data type, location, source, destination, etc. The raw network traffic telemetry data (142) may include any other information without departing from the invention.

In one or more embodiments, the processed training dataset (144) may refer to a processed version of the raw network traffic telemetry data (142) discussed above. This version of the data may be made suitable for analysis by the NNIDS (140) by removing noise and normalizing features for the purpose of analysis. Removing noise from the dataset may refer to filtering the data packets discussed above in the raw network traffic telemetry data (142) to only include relevant information. Normalizing features of the dataset may refer to standardizing the metadata of the data included in the data packets. The purpose of having this processed dataset is to train the intrusion detection model (146) below to establish an expected flow of traffic on the network. Based on the processed training dataset (144), the intrusion detection model (146) may be used to identify any anomalies and potential security risks in the network traffic.

In one or more embodiments, the intrusion detection model (146) may refer to a neural network architecture designed to recognize previous and new attack patterns. The intrusion detection model (146) may be trained using machine learning algorithms and the processed training dataset (144) discussed above in order to generate a model that recognizes an expected level of traffic on the network, and detects an anomaly to be further analyzed or remedied. If the NNIDS (140) determines, based on the intrusion detection model (146), that there is an anomaly, it will implement security measures from a data privacy protection policy (148), discussed in detail below.

In one or more embodiments, the data privacy protection policy (148) may refer to any policy that may be implemented by the NNIDS (140) on the system that will protect against an anomaly detected by the intrusion detection model (146). The data privacy protection policy (148) may include a set of conditions which require the implementation of security measures, information on security measure implementation, or security measures previously determined by an administrator. Security measures that may be implemented in the event that the NNIDS detects an anomaly may include shutting down the system so that no sensitive data can be accessed, flagging the source device that the anomaly is detected on for inspection, or notifying an administrator. The data privacy protection policy (148) may also include updated security measure implications that may be implemented in order to remediate each new anomaly detection. The data privacy protection policy (148) may include regulations in accordance with regional policies such as, for example, the General Data Protection Regulation (GDPR) or the California Consumer Privacy Act (CCPA). These sets of regulations may be set to enhance privacy rights and protect the personal information of individuals in the European Union and United States, respectively. The goal of the NNIDS is to fortify the security measures of the system, so when it detects an anomaly, it will implement data privacy protection measures in order to safeguard any sensitive information or data that may be stored by any systems on the network.

FIG. 2A shows a flowchart of a method for generating an intrusion detection model in accordance with one or more embodiments of the invention. The method may be performed by, for example, the NNIDS (140, FIG. 1A, FIG. 1B) Other components of the system illustrated in FIGS. 1A-1B may perform all, or a portion, of the method of FIG. 2A without departing from the invention.

While FIG. 2A is illustrated as a series of steps, any of the steps may be omitted, performed in a different order, include additional steps, and/or perform any or all of the steps in a parallel and/or partially overlapping manner without departing from the invention.

In Step 200, raw traffic data on the devices of the network is collected by the NNIDS. This data may include information about the type of data travelling through the system, its location, its destination, its file type, its size, etc. The raw traffic data from the network needs to be processed before it can be analyzed, as it may include excessive noise and exaggerate characteristics of the features of the data.

In Step 202, a processed traffic dataset is generated by the NNIDS. This dataset is processed by removing any unnecessary (or otherwise unused) noise from the data in the network traffic and normalize the features of the data. The processed traffic dataset may be used as the baseline level of traffic for the systems on the network, in order to have an expected flow of traffic. Once the data is processed, it may be used for training the intrusion detection model.

In Step 204, an intrusion detection model is generated based on the processed training dataset. Using the processed traffic dataset generated in Step 202, the NNIDS generates the intrusion detection model by training the model, using a neural network machine learning algorithm, for the purpose of identifying any traffic that may be classified as anomalies. The NNIDS may use the neural network architecture to generate the intrusion detection model, including both previously known attack patterns and those that exist as anomalies based on the processed traffic dataset. The intrusion detection model generated in this step may be used for the detection and remediation of anomalies as discussed in FIG. 2B.

FIG. 2B shows a flowchart of a method for generating an intrusion detection model in accordance with one or more embodiments of the invention. The method may be performed by, for example, the NNIDS (140, FIG. 1A, FIG. 1B) Other components of the system illustrated in FIGS. 1A-1B may perform all, or a portion, of the method of FIG. 2B without departing from the invention.

While FIG. 2B is illustrated as a series of steps, any of the steps may be omitted, performed in a different order, include additional steps, and/or perform any or all of the steps in a parallel and/or partially overlapping manner without departing from the invention.

In Step 210, the network traffic of the system is actively monitored in real time. This monitoring process may include continuously capturing and analyzing the raw network traffic of data transferred between devices in the system of FIG. 1A. The intrusion detection model generated in Step 204 of FIG. 2A is implemented in order to assist in the monitoring process.

In Step 212, all incoming raw traffic data is processed using the intrusion detection model. This dataset is processed in order to remove any unnecessary noise from the data and normalize the features of the data, making the data easier for the intrusion detection model to analyze and potentially detect an anomaly. The processing of the network traffic performed in Step 212 may be similar or substantially similar to the processing performed in Step 202.

In Step 214, a determination is made about whether or not an anomaly is detected in the network traffic data by the intrusion detection model. An anomaly may be any traffic detected on the network that is not typical based on the processed traffic dataset used to train the intrusion detection model, or potentially an attack by a malicious entity on the system. If the intrusion detection model detects an anomaly, the method proceeds to Step 216; if the intrusion detection model does not detect an anomaly, the method returns to Step 210.

In Step 216, the data privacy protection policy is implemented in order to remediate the anomaly detected in Step 214. The data protection policy may include any security measures implemented on the system by the NNIDS in order to protect sensitive data. Security measures that may be implemented in this step may include shutting down the system so that no sensitive data can be accessed, flagging the source device that the anomaly is detected on for inspection, or notifying an administrator that there is a security breach. Any data privacy measures implemented by the NNIDS are done with the intention of complying with regulations to safeguard any sensitive data.

In Step 218, documentation is generated by the NNIDS in order to update administrators of the system with the new privacy measures implemented in Step 216. This documentation may include information on the anomaly detected, such as the source device, as well as the data privacy protection policy implemented to remediate the anomaly.

In Step 220, the intrusion detection model is retrained based on the detected anomaly as well as the newly implemented privacy measures. This serves to continuously improve the intrusion detection model over time, and increase the security of the data in the system.

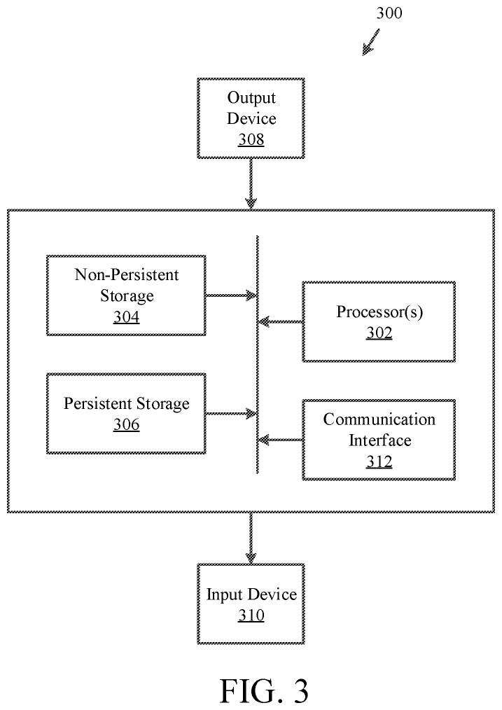

As discussed above, embodiments of the invention may be implemented using computing devices. Turning now to FIG. 3, FIG. 3 shows a diagram of a computing device in accordance with one or more embodiments of the invention. The computer (300) may include one or more computer processors (302), non-persistent storage (304) (e.g., volatile memory, such as random access memory (RAM), cache memory), persistent storage (306) (e.g., a hard disk, an optical drive such as a compact disk (CD) drive or digital versatile disk (DVD) drive, a flash memory, etc.), a communication interface (312) (e.g., Bluetooth® interface, infrared interface, network interface, optical interface, etc.), input devices (310), output devices (308), and numerous other elements (not shown) and functionalities. Each of these components is described below.

In one embodiment of the invention, the computer processor(s) (302) may be an integrated circuit for processing instructions. For example, the computer processor(s) (302) may be one or more cores or micro-cores of a processor. The computer (300) may also include one or more input devices (310), such as a touchscreen, keyboard, mouse, microphone, touchpad, electronic pen, or any other type of input device. Further, the communication interface (312) may include an integrated circuit for connecting the computer (300) to a network (not shown) (e.g., a local area network (LAN), a wide area network (WAN) such as the Internet, mobile network, or any other type of network) and/or to another device, such as another computing device.

In one embodiment of the invention, the computer (300) may include one or more output devices (308), such as a screen (e.g., a liquid crystal display (LCD), plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (302), non-persistent storage (304), and persistent storage (306). Many diverse types of computing devices exist, and the aforementioned input and output device(s) may take other forms.

One or more embodiments of the invention may be implemented using instructions executed by one or more processors of the cluster manager. Further, such instructions may correspond to computer readable instructions that are stored on one or more non-transitory computer readable mediums.

One or more embodiments of the invention may improve the detection of anomalies in network traffic that may alert a system to a security breach. Specifically, embodiments of the invention relate to a method of generating an intrusion detection model on a neural network intrusion detection system, of which the intrusion detection model is trained on continuously monitored traffic data of the network.

One or more embodiments of the invention relates to a method of utilizing processed network data to generate an intrusion detection model and subsequently implement the model in order to detect system anomalies. With this neural network technology, the intrusion detection model will not only be able to detect previously seen attacks, but also be able to identify novel and unknown attack patterns. Further, the neural network intrusion detection system may also include a data privacy protection policy that may be able to remediate the anomaly and notify an administrator, thus improving the security of the system.

The problems discussed above should be understood as being examples of problems solved by embodiments of the invention disclosed herein and the invention should not be limited to solving the same/similar problems. The disclosed invention is broadly applicable to address a range of problems beyond those discussed herein.

While the invention has been described with respect to a limited number of embodiments, those skilled in the art, having benefit of this disclosure, will appreciate that other embodiments can be devised which do not depart from the scope of the technology as disclosed herein. Accordingly, the scope of the invention should be limited only by the attached claims.

What is claimed is:

1. A method for managing intrusion detection, comprising:
monitoring, by a neural network intrusion detection system (NNIDS), network traffic between a plurality of devices in a system to obtain raw traffic data, wherein the raw traffic data comprises data packets sent from one of the plurality of devices to another of the plurality of devices;
processing the raw traffic data to obtain processed traffic data;
applying an intrusion detection model to the processed traffic data;
making a determination, based on the applying, that an anomaly is detected in the processed traffic data; and
based on the determination, implementing a data privacy protection policy to remediate the anomaly.

2. The method of claim 1, further comprising:
collecting, by the NNIDS, second raw traffic data;
processing the second raw traffic data to generate a training dataset; and
generating, using a neural network architecture and the training dataset, the intrusion detection model.

3. The method of claim 1, wherein processing the raw traffic data comprises removing noise and normalizing features for the intrusion detection model, wherein removing the noise comprises filtering the data packets to include relevant information, and wherein normalizing the features comprises standardizing metadata included in the data packets.

4. The method of claim 1, wherein the data privacy protection policy comprises a mapping between the anomaly and a remediation action for remediating the anomaly.

5. The method of claim 4, wherein the remediation action comprises notifying an administrator of the anomaly.

6. The method of claim 4, wherein the remediation action comprises flagging a source device sending network traffic associated with the anomaly.

7. The method of claim 1, further comprising:
after remediating the anomaly, performing a retraining of the intrusion detection model based on the determination and based on the implementing.

8. The method of claim 1, further comprising:
after remediating the anomaly, generating documentation based on the implementation of the data privacy protection policy and based on the anomaly.

9. A non-transitory computer readable medium comprising computer readable program code, which when executed by a computer processor enables the computer processor to perform a method for managing remote memory, the method comprising:
monitoring, by a neural network intrusion detection system (NNIDS), network traffic between a plurality of devices in a system to obtain raw traffic data;
processing the raw traffic data to obtain processed traffic data;
applying an intrusion detection model to the processed traffic data;
making a determination, based on the applying, that an anomaly is detected in the processed traffic data; and
based on the determination, implementing a data privacy protection policy to remediate the anomaly.

10. The non-transitory computer readable medium of claim 9, further comprising:
collecting, by the NNIDS, second raw traffic data;
processing the second raw traffic data to generate a training dataset; and
generating, using a neural network architecture and the training dataset, the intrusion detection model.

11. The non-transitory computer readable medium of claim 9, wherein processing the raw traffic data comprises removing noise and normalizing features for the intrusion detection model.

12. The non-transitory computer readable medium of claim 9, wherein the data privacy protection policy comprises a mapping between the anomaly and a remediation action for remediating the anomaly.

13. The non-transitory computer readable medium of claim 12, wherein the remediation action comprises notifying an administrator of the anomaly.

14. The non-transitory computer readable medium of claim 9, further comprising:
after remediating the anomaly, performing a retraining of the intrusion detection model based on the determination and based on the implementing.

15. The non-transitory computer readable medium of claim 9, further comprising:
after remediating the anomaly, generating documentation based on the implementation of the data privacy protection policy and based on the anomaly,
wherein the document generation process comprises generating an entry that specifies the anomaly and a remediation action associated with the anomaly.

16. A system for managing remote memory, comprising:
a processor; and
memory comprising instructions, which when executed by the processor, perform a method comprising:
monitoring, by a neural network intrusion detection system (NNIDS), network traffic between a plurality of devices in a system to obtain raw traffic data;
processing the raw traffic data to obtain processed traffic data;
applying an intrusion detection model to the processed traffic data;
making a determination, based on the applying, that an anomaly is detected in the processed traffic data; and
based on the determination, implementing a data privacy protection policy to remediate the anomaly.

17. The system of claim 16, the method further comprising:
collecting, by the NNIDS, second raw traffic data;
processing the second raw traffic data to generate a training dataset; and
generating, using a neural network architecture and using the training dataset, the intrusion detection model.

18. The system of claim 16,
wherein processing the raw traffic data comprises removing noise and normalizing features for the intrusion detection model,
wherein the data privacy protection policy comprises a mapping between the anomaly and a remediation action for remediating the anomaly.

19. The system of claim 18, wherein the remediation action comprises notifying an administrator of the anomaly.

20. The system of claim 16, further comprising:
after remediating the anomaly:
performing a retraining of the intrusion detection model based on the determination and based on the implementing; and
generating documentation based on the implementation of the data privacy protection policy and based on the anomaly.
